(19) United States
(12) Patent Application Publication
(10) Pub. No.: US 2006/0070820 A1
(43) Pub. Date: Apr. 6, 2006

(54) Door gap monitoring

(75) Inventor: Friedrich Hackl, Winklarn (AT)

Correspondence Address: BARNES & THORNBURG, 750-17TH STREET NW, SUITE 900, WASHINGTON, DC, 20006, US

(73) Assignee: Knorr-Bremse Gesellschaft Mit Beschrankter Haftung, Modlich (AT)

(21) Appl. No.: 10/515,199

(22) PCT Filed: May 20, 2003
(86) PCT No.: PCT/EP03/05269

§ 371 Date: Nov. 7, 2005

(30) Foreign Application Priority Data
May 22, 2002 (AT) A 780/2002

(51) Int. Cl. B66B 13/14

(52) U.S. Cl. 187/316

(57) ABSTRACT

The invention relates to a device for monitoring the door gap of doors used in rail vehicles, elevators or the like, comprising at least one door leaf whose main closing edge thereof is optionally provided with an elastically deformable or elastically mounted profile, and relates to a method for monitoring such a door gap. The invention is characterized in that the device is activated when each door leaf of the doors is located in a closed final position, and in that the monitoring is effected by pneumatic, optical, inductive, capacitive or magnetic sensors or by combinations of sensors of these types. In principle, these sensors measure a physical quantity that corresponds to the shape or position of the gap/profile and is compared to the quantity of the proper shape/position of the gap/profile.

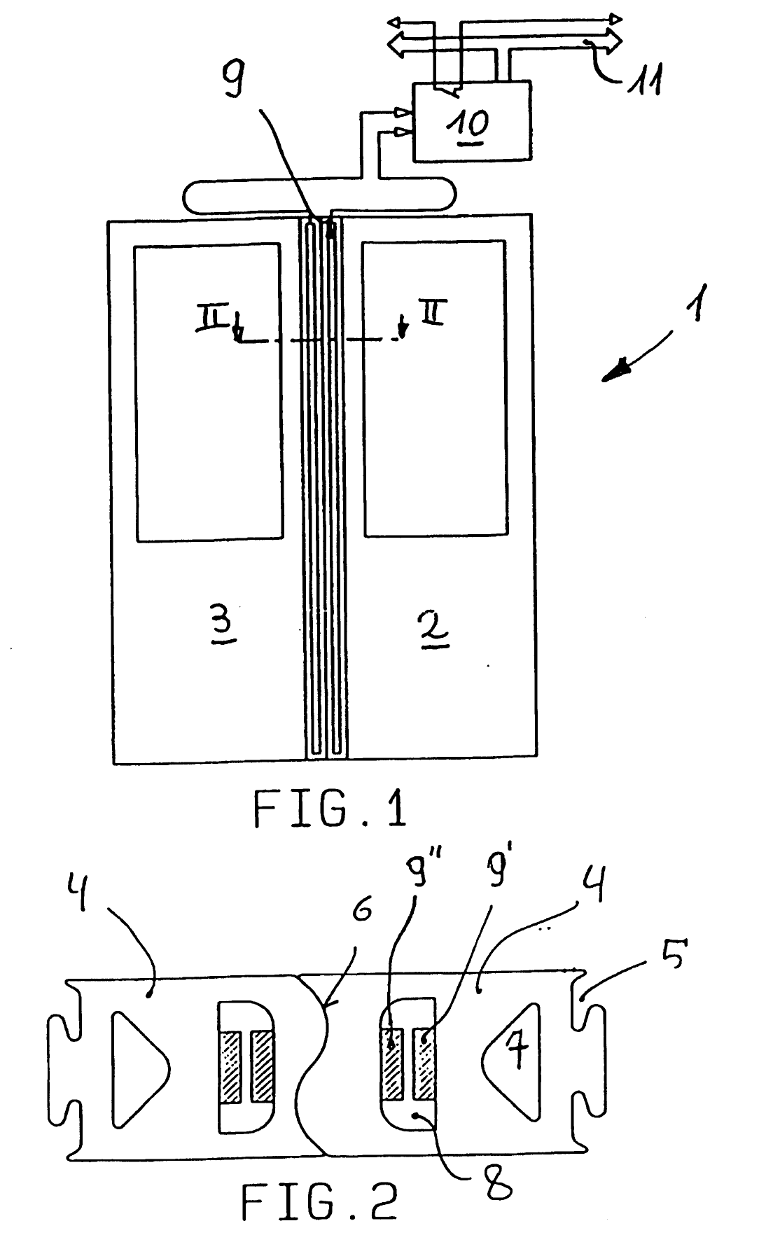

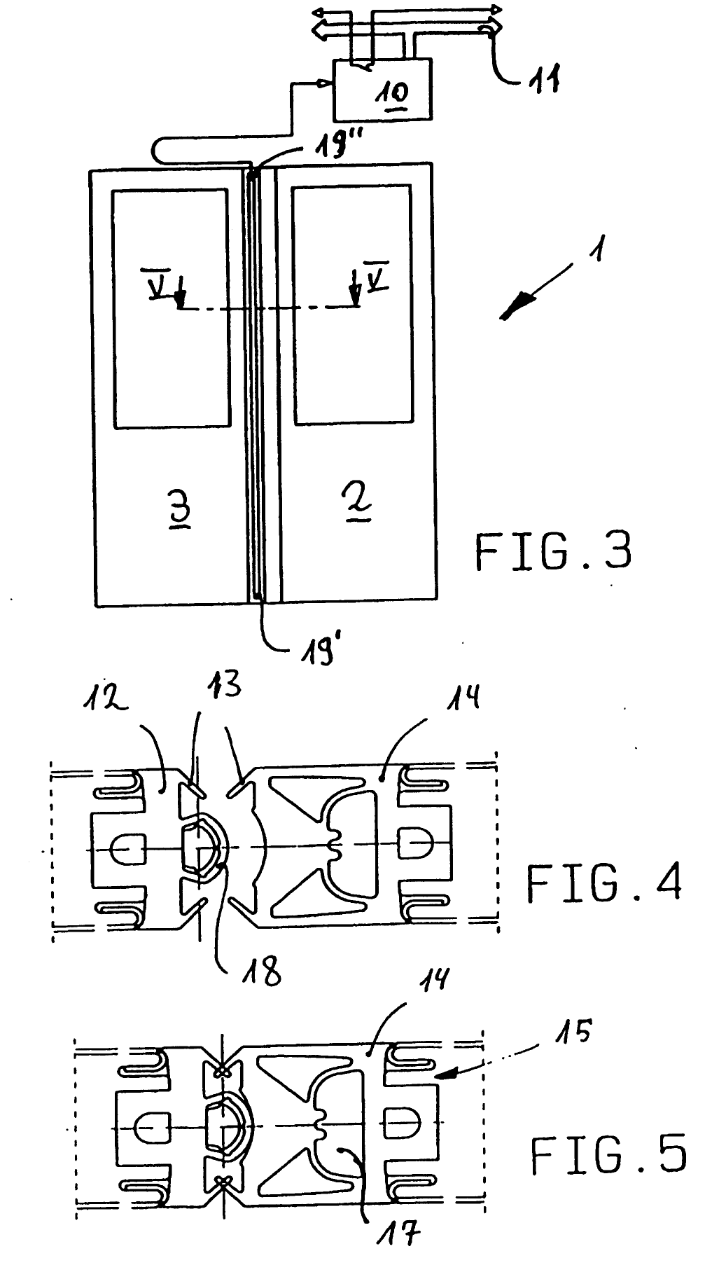

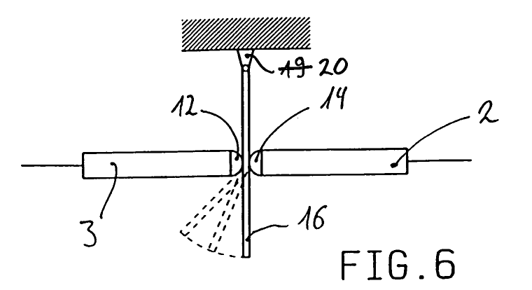

The invention relates to a method of monitoring the door gap of doors of rail vehicles, elevators, or the like, according to the introductory part of Claim 1.

Swiss Patent Document CH 688 354 A relates to the problem on which the invention is based which is that of detecting the jamming-in of small or thin objects when closing doors. The solution suggested by this document is the following: Hollow profiles are provided on the closing edges and have at least one cross-sectional area responsible for the sealing and at least one cross-sectional area responsible for detecting thin jammed-in objects. The area responsible for determining jamming-in events is constructed such that, also in the closed final position of the door, in the disturbance-free operation, it is subjected to no deformation. On the other hand, it is constructed such that it is impossible to bring objects, also thin objects, normal to the closing plane, into the detection area of the profile without deforming this area when the closing operation is completed or almost completed. This is achieved in that the detection areas of the two profiles have an overlapping construction in the direction normal to the closing plane, whereby each object extending diagonally or normal to the closing plane and projecting through the plane leads to a deformation of this area.

This solution requires that the detection areas of the profile do not deform during the closing operation despite the occurring vibrations and shocks, which, however, is not so in practice, because, for example, as a result of aging processes or damaging of the plastic profile, it may occur that the two actual sensor edges do not move past one another but strike again one another and thereby trigger an alarm.

U.S. Pat. No. 4,803,807 A corresponding to European Patent Document EP 0 254 038 A suggests that the closing force of a pneumatically operated door leaf be monitored by a closing force sensor and, in the event of the exceeding of a preset limit value, that the cylinder be lifted by way of an solenoid valve in order to make it possible to free the jammed-in object or the squeezed-in person. Also this arrangement is activated along the entire closing path and therefore has to be set to be slow or insensitive in order not to be activated erroneously. European Patent Document EP 1 054 128 A provides, in the case of vehicle doors (only pneumatic drives are disclosed) that the closing force during the entire closing movement and for a certain time beyond it (this time can be defined either by the speed of the vehicle, by a time switch, by a manual operation or other factors) be limited to a defined, not very high value, in order to make it possible to free jammed-in objects or persons, in that the door is opened against this low closing force and the jamming-in is eliminated. For safety reasons, this closing force is markedly increased only after the time has elapsed, in order to reliably avoid an opening of the door during the travel. The jamming-in of thin objects cannot be detected by means of this arrangement.

In general terms, the many different safety devices in the case of doors of rail vehicles or elevators, but also gondolas of cable cars, etc., monitor many different parameters, particularly during the closing of the door. This may be the force required for the closing, from which it is derived whether the pressure of objects or persons against the door prevents the closing movement; this may be the closing speed, from which conclusions can be drawn also with respect to jammed-in persons or objects; this may be deformations on the main closing edge, which is usually formed of a relatively voluminous rubber profile, indicating that the door has encountered an obstacle in the course of the closing movement; and similar situations.

The reaction to the determination of an obstacle or a jammed-in object or of a body part, differs according to the application. In some cases, it is required that the closing movement is changed into an opening movement, and the door does not start the closing movement again before a predetermined time has elapsed. In other cases, only a stoppage of the door for a predetermined time period is required; in other cases, only a brief and locally limited reversal of the movement takes place for allowing the squeezed-in persons to free themselves. There are also many other possibilities. Door control systems also exist in which the reaction to the detection of a jammed-in object is different the first time during a closing movement than subsequently in order to prevent vandals and saboteurs from willfully blocking the closing of the door.

In the case of all these systems, a differentiation must necessarily be made as to the position in which the door is during the closing when it impacts on an obstacle because the reactions should be different depending on the position. Particularly in the last closing end range, in which the main closing edge of the door leaf has approached the door frame or the main closing edge of the second door leaf to such an extent that no arm or leg or bag or similarly voluminous object can be squeezed in because this would otherwise already have been determined in a more open position of the door leaf, as a result of the dynamic stressing of the door leaf and the connected vibrations and shocks, the reaction threshold of the sensors is increased to an extreme degree, or the safety devices are completely switched off in order to permit a closing of the door, without an opening of the door taking place only as a result of vibrations occurring during the movement into the closed final position.

These systems have essentially been successful. However, in the course of efficiency and savings measures, changes are being made in that not only, as previously, elevators are operated unmanned but also subways, commuter trains and the like and the operation is monitored only from a central master station location, which can take place with clearly less personnel than in the conventional manned operation.

In contrast to the manned operation, this type of operation carries the risk that thin objects may be squeezed in at the end of the closing end movement without any detection of this squeezing-in by the conventional safety systems. Since no visual control takes place along the train, this previously easy and reliable detection of the jamming-in of a walking cane, a crutch, a dog leash, and the like becomes impossible in this new type of operation and thus leads to a spectacular risk.

It is an object of the invention to avoid this risk and to suggest a protection which is capable of reliably detecting such objects or their squeezing-in.

According to the invention, this is implemented by the characteristics indicated in the characterizing part of Claim 1.

As indicated above, it is not necessary for the door gap monitoring according to the invention to be activated during the closing of the door. The door gap monitoring according to the invention therefore does not change the behavior of a given automatic closing system and can therefore also be installed subsequently in an easy manner and without any problems.

It is essential that the device according to the invention or the method according to the invention for monitoring the door gap is activated or carried out after the closing of the doors has taken place and it is then determined whether the shape of the main closing edge of the door, normally formed of an elastic

1. A method of monitoring the door gap of doors of rail vehicles, elevators or the like, having at least one door leaf, which is equipped on its main closing edge with an elastically deformable or elastically mounted profile, whose position and/or shape is detected by electric, pneumatic, optical, inductive, capacitive or magnetic sensors or a combination of such sensors in connection with an electronic monitoring system which analyzes the signals of the sensors and, if applicable, determines the jamming-in of an object, a person or the like in the door gap, the method comprising
the electronic monitoring system not activated during the closing of the door and before each of the door leaves of the door is in its closed final position, the electronic monitoring system being deactivated after one of a predetermined time interval and when a predetermined event occurs.

2. The method according to claim 1,
wherein the predetermined event is the reaching of a defined speed of the vehicle.

3. The method according to claim 1,
wherein the predetermined event is the passing by a signal generator on the route of the vehicle.

4. The method according to claim 1,
wherein the electronic monitoring system has a delay element which causes the activation of the monitoring device after a predetermined time interval, starting with the reaching of the closed final position of each of the door leaves.

5. The method according to claim 1,
wherein a measured quantity of the sensor which corresponds to the actual shape or position of the profile is transmitted to the electronic monitoring system, and is compared with a reference quantity which corresponds to the measured quantity of the shape or position of the profile in the properly closed condition of the door leaf.
